(19) United States
(12) Patent Application Publication
(10) Pub. No.: US 2014/0096990 A1
(43) Pub. Date: Apr. 10, 2014

(54) PORTABLE POWER TOOL

(71) Applicant: Robert Bosch GmbH, Stuttgart (DE)

(72) Inventor: Thomas Weller, Leinfelden-Echterdingen (DE)

(73) Assignee: Robert Bosch GmbH, Stuttgart (DE)

(21) Appl. No.: 14/047,702

(22) Filed: Oct. 7, 2013

(30) Foreign Application Priority Data
Oct. 8, 2012 (DE) 10 2012 218 272.1

(51) Int. Cl. B25B 21/00; B25F 5/00

(52) U.S. Cl. CPC B25B 21/00; B25F 5/00
USPC 173/217; 173/170

(57) ABSTRACT

A portable power tool, in particular a portable screwdriver, includes a tool-holding fixture, at least one active drive unit that has at least one motor unit, and at least one electric switching element configured to activate a rotational movement of the motor unit. The portable power tool further includes at least one mechanical switching element configured to transmit a switching signal along an axis of rotation of the tool-holding fixture to the electric switching element over at least part of the active drive unit.

This application claims priority under 35 U.S.C. §119 to patent application no. DE 10 2012 218 272.1, filed on Oct. 8, 2012 in Germany, the disclosure of which is incorporated herein by reference in its entirety.

### BACKGROUND

A portable power tool, in particular a portable screwdriver, has already been proposed, with a tool-holding fixture, with at least one active drive unit which comprises at least one motor unit, and with at least one electric switching element for activating a rotational movement of the motor unit.

### SUMMARY

The disclosure is based on a portable power tool, in particular on a portable screwdriver, with a tool-holding fixture, with at least one active drive unit which comprises at least one motor unit, and with at least one electric switching element for activating a rotational movement of the motor unit.

It is proposed that the portable power tool has at least one mechanical switching element for transmitting a switching signal along an axis of rotation of the tool-holding fixture to the electric switching element over at least part of the active drive unit. A “portable power tool” is intended in this context to be understood as meaning, in particular, a workpiece-machining machine, but advantageously a drill, a hammer drill and/or strike hammer, a saw, a plane, a screwdriver, a mortiser, a grinder, an angle grinder, a garden implement and/or a multifunctional tool. It is preferably intended to be understood as meaning, in particular, a portable power tool which can be transported by an operator without a transport machine. The portable power tool particularly preferably has, in particular, a mass which is smaller than 40 kg, and is preferably smaller than 10 kg and particularly preferably is smaller than 5 kg. Furthermore, a “tool-holding fixture” is intended in this context to be understood as meaning, in particular, an element of the portable power tool that is provided for directly fastening, at least in a rotationally fixed manner, a tool releasably inserted by an operator. This is preferably intended to be understood as meaning, in particular, an element with a receiving region which has at least one contour, in particular a hexagonal contour, for the rotationally fixed fastening of an inserted tool. The tool-holding fixture particularly preferably has a magnetic bit holder. Furthermore, an “active drive unit” is intended in this context to be understood as meaning, in particular, a drive unit which comprises at least all parts and/or all units of a drive train of the portable power tool that are directly provided for changing and/or for producing a torque transmitted along the drive train and/or, in particular, a rotational speed transmitted along the drive train. In this context, a “drive train” is intended here to be understood as meaning, in particular, all elements of the portable power tool which are provided in an operation for transmitting a rotational speed and/or a torque from the motor unit to a tool arranged in the tool-holding fixture. A “motor unit” is intended in this context to be understood as meaning, in particular, an electric and/or mechanical and/or pneumatic unit which is advantageously provided in an operation for producing a rotational movement. Various motor units appearing expedient to a person skilled in the art are conceivable, but, advantageously, it is intended to be understood as meaning, in particular, an electric motor. Furthermore, an “electric switching element” is intended in this context to be understood as meaning, in particular, an electric element which is provided for producing and/or for severing an electrically conductive connection between two points, in particular contacts of the switching element. It is preferably intended to be understood as meaning, in particular, an electric element which is provided for producing and/or for severing an electrically conductive connection by means of electrically conductive materials and/or by means of a semiconductor component. Furthermore, a “mechanical switching element” is intended in this context to be understood as meaning, in particular, a mechanical element which is provided for transmitting a switching signal and/or a switching pulse. A transmission preferably takes place, in particular, by the movement of at least part of the switching element and/or by static forces, such as, in particular, a permanent magnetic field. A “switching signal” is intended in this context to be understood as meaning, in particular, a signal which is provided at least in and/or before operation of the portable power tool for changing a switching state of at least one switching element and/or for activating the portable power tool. It is preferably intended to be understood as meaning, in particular, a technical signal, such as, in particular, a mechanical signal. It is particularly preferably intended to be understood as meaning, in particular, a signal which is formed by a movement. An “axis of rotation” is intended in this context to be understood as meaning, in particular, an axis about which the tool-holding fixture rotates in a regular operation. Furthermore, “at least part of the active drive unit” is intended in this context to be understood as meaning, in particular, at least one element and/or, in particular, at least one unit of the active drive unit.

By means of the configuration according to the disclosure of the portable power tool, a signal transmission for activating a rotational movement of the motor unit can advantageously take place mechanically over at least part of the active drive unit. Furthermore, an advantageously compact arrangement of electric components can thereby be achieved. Furthermore, a particularly advantageous signal transmission can thereby be provided.

It is furthermore proposed that the mechanical switching element is provided for transmitting a switching signal along the axis of rotation of the tool-holding fixture to the electric switching element over the entire active drive unit. As a result, a signal transmission for activating a rotational movement of the motor unit can advantageously take place mechanically over the entire active drive unit.

Furthermore, it is proposed that the mechanical switching element is formed by a switching slide. A “switching slide” is intended in this context to be understood as meaning, in particular, an element, in particular an at least approximately web-shaped element, which is provided to be moved for transmitting a switching signal. The element is preferably provided to be displaced in a translatory manner, in particular at least approximately along a main direction of extent, for transmitting a switching signal. “At least approximately” is intended here to be understood as meaning, in particular, a deviation from a predetermined value of at maximum 20°, preferably at maximum 10° and particularly preferably at maximum 5° and/or at maximum 20%, preferably at maximum 10% and particularly preferably at maximum 5%. Furthermore, a “main direction of extent” is intended here to be understood as meaning, in particular, a direction of a longest edge of a smallest geometrical rectangular parallelepiped which still precisely surrounds the switching slide. A particularly advantageous and structurally simple switching element can thereby be provided. Furthermore, by designing the switching element as a switching slide, a large distance can advantageously be bridged.

Furthermore, it is proposed that a region of the switching slide that faces away from the tool-holding fixture has a subregion which is angled in relation to the axis of rotation of the tool-holding fixture. A region of the switching slide that faces away from the tool-holding fixture preferably has a subregion which is angled by at least approximately 90° in relation to the axis of rotation of the tool-holding fixture. An “angled subregion” is intended in this context to be understood as meaning, in particular, a subregion of the switching slide, the main plane of extent of which has a normal which is angled in relation to a normal of a main plane of extent of a subregion differing from the subregion. A “main plane of extent” of a unit and/or of a region here is intended to be understood as meaning, in particular, a plane which is parallel to a largest side surface of a smallest geometrical rectangular parallelepiped which precisely still entirely encloses the unit and/or the region, and, in particular, runs through the center point of the rectangular parallelepiped. Furthermore, “angled in relation to the axis of rotation of the tool-holding fixture” is intended to be understood as meaning, in particular, that an angle between the normal of the main plane of extent of the subregion and the axis of rotation differs in its value in relation to an angle between the normal of the main plane of extent of the differing subregion. Furthermore, “angled by at least approximately 90°” is intended in this context to be understood as meaning, in particular, that the normal of the main plane of extent of the subregion is parallel with a deviation of at maximum 20°, preferably of at maximum 10° and particularly preferably of at maximum 5° in relation to the axis of rotation of the tool-holding fixture. As a result, an advantageous and reliable signal transmission to the electric switching element can be achieved. An advantageous and reliable transmission of force can preferably be achieved as a result.

It is furthermore proposed that the switching signal is at least partially formed by an axial movement of the tool-holding fixture relative to at least part of the active drive unit. Accordingly, a motor unit can preferably be activated by the application of a contact pressure force. “At least partially” is intended in this context to be understood as meaning, in particular, that a deviation from a predetermined value is at maximum 30%, preferably at maximum 15% and particularly preferably at maximum 5%. An “axial movement” is intended in this context to be understood as meaning, in particular, a movement parallel to an axis of rotation of the tool-holding fixture. A reliable switching signal can advantageously be provided as a result. Furthermore, a contact pressure force which has to be applied in any case can thereby advantageously be used to displace the tool-holding fixture axially and therefore to realize the required switching signal for activating a rotational movement of the motor unit.

Furthermore, it is proposed that the mechanical switching element is formed at least partially in a form-fitting manner with the tool-holding fixture. “At least partially in a form-fitting manner” is intended in this context to be understood as meaning, in particular, that the mechanical switching element is formed in a form-fitting manner with the tool-holding fixture at least in the radial and/or in the axial direction and/or in the circumferential direction of the tool-holding fixture. It is preferably intended to be understood as meaning that the mechanical switching element is formed in a form-fitting manner with the tool-holding fixture at least in the radial and axial direction of the tool-holding fixture. This makes it possible to realize an advantageous transmission of force and/or movement of the tool-holding fixture to the mechanical switching element.

It is furthermore proposed that the mechanical switching element has a ring element on a side facing the tool-holding fixture for the form-fitting connection to the tool-holding fixture. A “ring element” is intended in this context to be understood as meaning, in particular, an at least partially annular element which has at least one contour, in particular an inner contour, which is at least approximately circular or in the shape of an arc of a circle. A “ring element” in this context can be understood basically as meaning a closed or an open ring. An inner contour of the ring element is preferably closed over more than 180°, preferably over more than 250° and particularly preferably over more than 320°. As a result, a particularly reliable and structurally simple fastening of the mechanical switching element to the tool-holding fixture can advantageously be realized. Furthermore, a degree of freedom between the tool-holding fixture and the mechanical switching element in the circumferential direction of the tool-holding fixture can be achieved in a structurally simple manner by this means.

Furthermore, it is proposed that the motor unit has at least one flattened portion running parallel to an axis of rotation of the motor unit. An “axis of rotation” is intended in this context to be understood as meaning, in particular, an axis about which the motor unit rotates in a regular operation. Furthermore, a “flattened portion” is intended in this context to be understood as meaning, in particular, a subregion of a body which has an at least substantially flat surface which deviates from a basic shape of the body. It is preferably intended to be understood as meaning, in particular, a flat subregion in an otherwise at least approximately cylindrical body. The flattened portion particularly preferably constitutes a theoretical abrasion of material in relation to a basic shape of the body. An “at least substantially flat surface” here is intended to be understood as meaning, in particular, a flat surface which takes up at least 50%, preferably at least 70% and particularly advantageously at least 90% of the subregion. This makes it possible to provide an advantageously compact motor unit. Furthermore, the flattened portion makes it possible to provide a motor unit which is powerful by comparison to a motor unit with a reduced diameter.

Furthermore, it is proposed that the mechanical switching element is led past the motor unit in a region of the flattened portion. “Led past” is intended in this context to be understood as meaning, in particular, that the mechanical switching element extends at least over the entire motor unit, in particular along the axis of rotation of the motor unit. This is preferably to be understood as meaning that the mechanical switching element extends past the motor unit without making contact therewith. As a result, a particularly compact construction of the portable power tool can be achieved. Furthermore, a particularly small cross section can be achieved as a result, in particular in the region of the motor unit.

It is furthermore proposed that the mechanical switching element is formed by a magnet element which is provided for transmitting a switching signal to the electric switching element over at least part of the active drive unit. A “magnet element” is intended in this context to be understood as meaning, in particular, a magnetic element which attracts or repels certain bodies. It is preferably intended to be understood as meaning, in particular, a magnet element which is provided for producing a static magnetic field. Various magnet elements appearing expedient to a person skilled in the art are conceivable, but it is intended to be understood as meaning, in particular, a permanent magnet. This makes it possible, in particular, to provide a compact mechanical switching element.

It is furthermore proposed that the electric switching element is formed by a Reed switch. A “Reed switch” is intended in this context to be understood as meaning, in particular, an electric switch which is provided to be actuated when a magnetic field approaches. It is preferably intended to be understood as meaning a switch with at least two magnetic or magnetizable contact elements which move towards each other when a magnetic field approaches and finally close a contact. This makes it possible, in particular, to provide an electric switching element which is actuated by a magnetic, mechanical switching element. As a result, in particular, a compact construction can be achieved. Furthermore, a switching signal can be transmitted by a magnetic field via the air.

It is furthermore proposed that the switching slide is at least partially produced from polyoxymethylene. In principle, however, other technical plastics appearing expedient to a person skilled in the art are also conceivable. A “technical plastic” is intended in this context to be understood as meaning, in particular, a plastic which is provided for producing technical components. This is preferably intended to be understood as meaning, in particular, a polymer, particularly preferably a thermoplastic polymer. Various technical plastics appearing expedient to a person skilled in the art are conceivable, such as, in particular, acrylonitrile-butadiene-styrene, polyamide, polypropylene, a styrene block copolymer or polyoxymethylene. A high degree of rigidity of the switching slide can advantageously be achieved as a result. Furthermore, a low coefficient of friction can be provided by the material. Furthermore, a high degree of dimensional stability can be provided, and therefore, in particular, an undesirable activation of the portable power tool as a result of an expansion in length of the switching slide can be prevented.

The portable power tool according to the disclosure is not intended to be restricted here to the above-described use and embodiment. In particular, the portable power tool according to the disclosure can have a number of individual elements, components and units that differs from a number referred to herein in order to carry out a function described herein.

### BRIEF DESCRIPTION OF THE DRAWINGS

Further advantages emerge from the description below of the drawings. Six exemplary embodiments of the disclosure are illustrated in the drawings. The drawings, the description and the claims contain numerous features in combination. A person skilled in the art will expediently also consider the features individually and put them together to form meaningful further combinations.

In the drawings:

FIG. 1 shows a schematic illustration of a portable power tool according to the disclosure with a user gripping position indicated,

FIG. 2 shows the portable power tool according to the disclosure in a schematic sectional illustration with a section plane parallel to a main direction of extent of the portable power tool,

FIG. 3 shows the portable power tool according to the disclosure in an alternative schematic partial sectional illustration with a section plane rotated through 90° in relation to FIG. 2,

FIG. 4 shows a partial cutout of the portable power tool according to the disclosure in a schematic full sectional illustration with a section plane corresponding to FIG. 3,

FIG. 5 shows a schematic sectional illustration of a tool-holding fixture, a drive spindle, a mechanical switching element and an electric switching element of the portable power tool according to the disclosure in a basic position,

FIG. 6 shows a schematic sectional illustration of the tool-holding fixture, the drive spindle, the mechanical switching element and the electric switching element of the portable power tool according to the disclosure in an operating position,

FIG. 7 shows a schematic exploded illustration of the tool-holding fixture and the drive spindle with a form-fitting connection of the portable power tool according to the disclosure,

FIG. 8 shows the portable power tool according to the disclosure in a schematic sectional illustration with a section plane perpendicular to a main direction of extent of the portable power tool,

FIG. 9 shows a schematic sectional illustration of a tool-holding fixture, a drive spindle, a mechanical switching element and a resetting element of an alternative portable power tool according to the disclosure,

FIG. 10 shows a schematic exploded illustration of a tool-holding fixture and a drive spindle with a form-fitting connection of a further alternative portable power tool according to the disclosure,

FIG. 11 shows a schematic sectional illustration of the form-fitting connection of the tool-holding fixture and of the drive spindle of the further alternative portable power tool according to the disclosure in a fitted state,

FIG. 12 shows a schematic illustration of a tool-holding fixture and a mechanical switching element of a further alternative portable power tool according to the disclosure,

FIG. 13 shows a schematic sectional illustration of a tool-holding fixture, a drive spindle, a mechanical switching element and an electric switching element of a further alternative portable power tool according to the disclosure, and

FIG. 14 shows a schematic illustration of a sensor unit of a further alternative portable power tool according to the disclosure.

### DETAILED DESCRIPTION

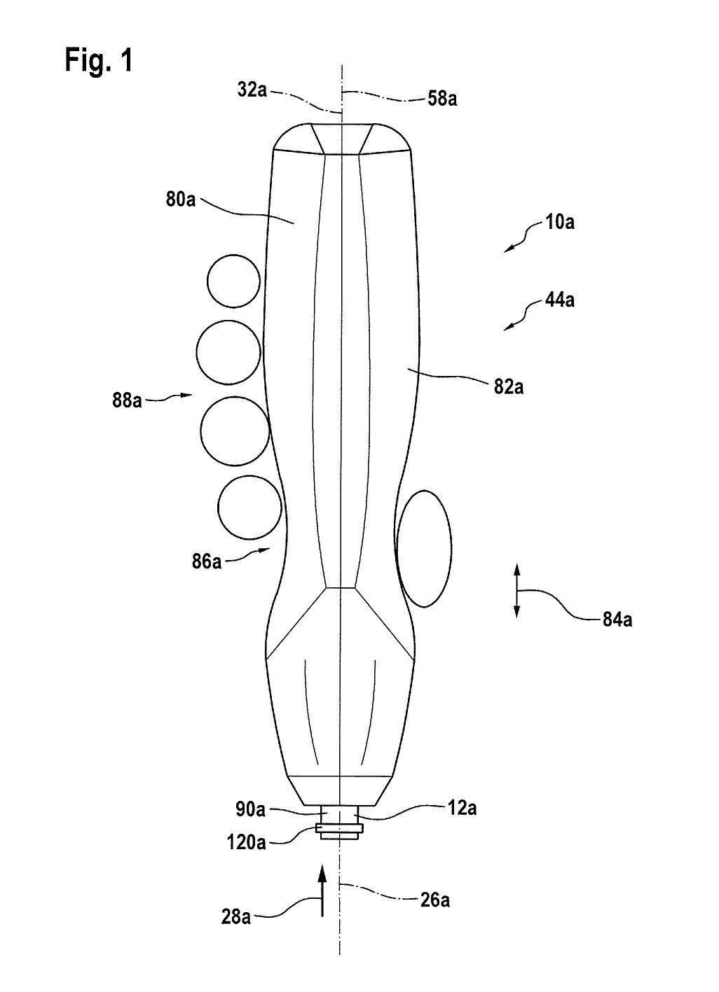

FIG. 1 shows a portable power tool 10a according to the disclosure with a user gripping position indicated. The portable power tool 10a is formed by a portable screwdriver. The portable power tool 10a is approximately in the shape of a screwdriver. The portable power tool 10a has a housing unit 44a and a tool-holding fixture 12a. The housing unit 44a is of two-part design. The housing unit 44a has two housing shell elements 80a, 82a. In a fitted state, the two housing shell elements 80a, 82a are provided for surrounding components of the portable power tool 10a. The tool-holding fixture 12a partially protrudes out of the housing unit 44a. The tool-holding fixture 12a partially protrudes out of the housing unit 44a in a front region of the portable power tool 10a, as viewed along a main direction of extent 84a of the portable power tool 10a. In principle, however, it would also be conceivable for the tool-holding fixture 12a to end flush with the housing unit 44a or to be partially recessed in the housing unit 44a. The housing unit 44a of the portable power tool 10a has a tapered portion 86a in a central region, as viewed along the main direction of extent 84a of the portable power tool 10a. The tapered portion 86a is intended to make it difficult for a user's hand 88a to slide in the axial direction along the main direction of extent 84a. The tapered portion 86a is provided for receiving a thumb and an index finger of the user's hand 88a during operation of the portable power tool 10a. In principle, however, it would also be conceivable for the housing unit 44a to have an elevation in a central region, as viewed along the main direction of extent 84a of the portable power tool 10a.

On a side facing away from the housing unit 44a, the tool-holding fixture 12a of the portable power tool 10a has a magnetic bit holder 90a with a hexagonal inner contour. The bit holder 90a is provided for receiving a bit. The tool-holding fixture 12a is sintered and is subjected to a curing process during production. Calibrated tools are used for the sintering.

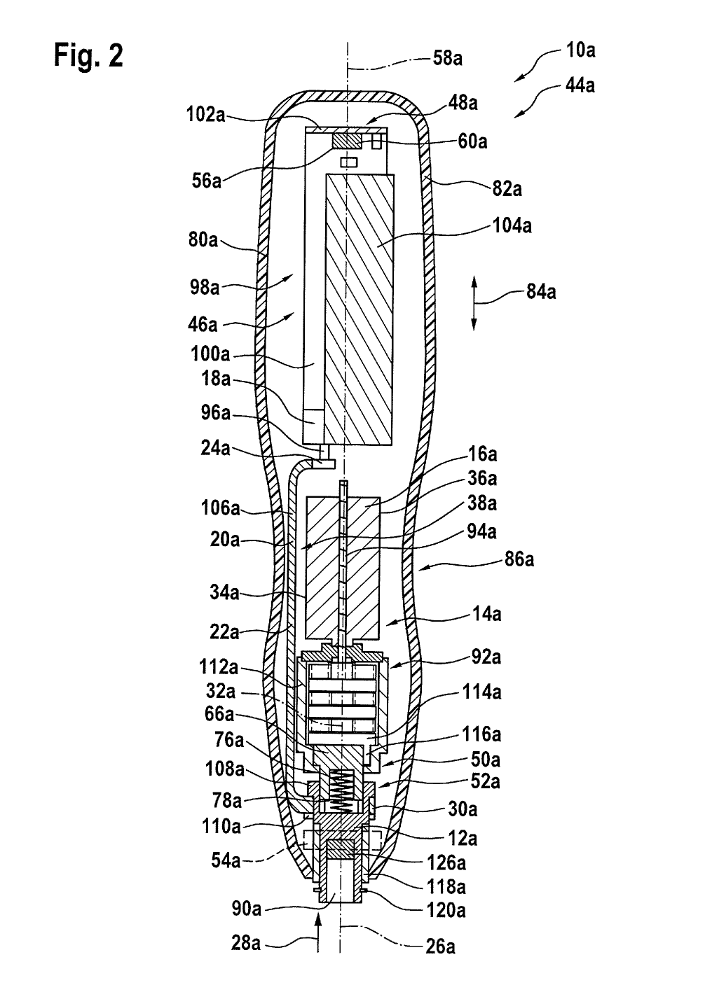

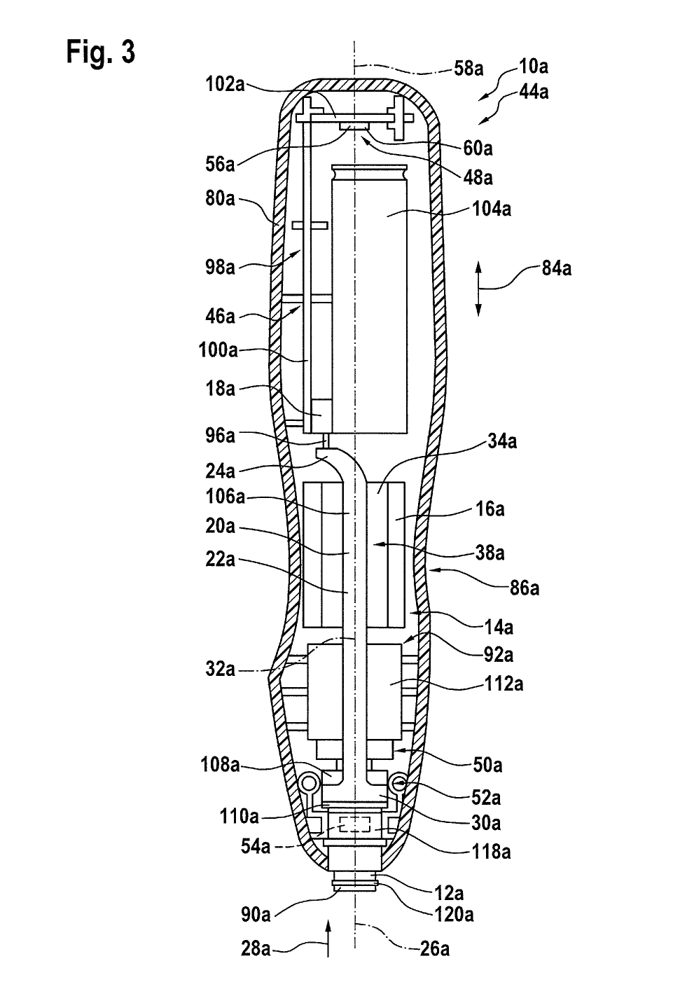

Furthermore, the portable power tool 10a has an active drive unit 14a. The active drive unit 14a comprises a motor unit 16a and a gearing unit 92a. The motor unit 16a and the gearing unit 92a are arranged in the housing unit 44a one behind the other along the main direction of extent 84a of the portable power tool 10a. The motor unit 16a and the gearing unit 92a are directly connected to each other in order to transmit a rotational speed and a torque. The motor unit 16a has a motor shaft 94a which projects directly into the gearing unit 92a. As a result, in particular, a compact construction can be achieved (FIGS. 2 and 3).

The gearing unit 92a is formed by a planetary gearing. The gearing unit 92a is formed by a planetary gearing with three gearing stages. The gearing unit 92a has a housing unit 112a which surrounds a remaining part of the gearing unit 92a (FIGS. 2, 3).

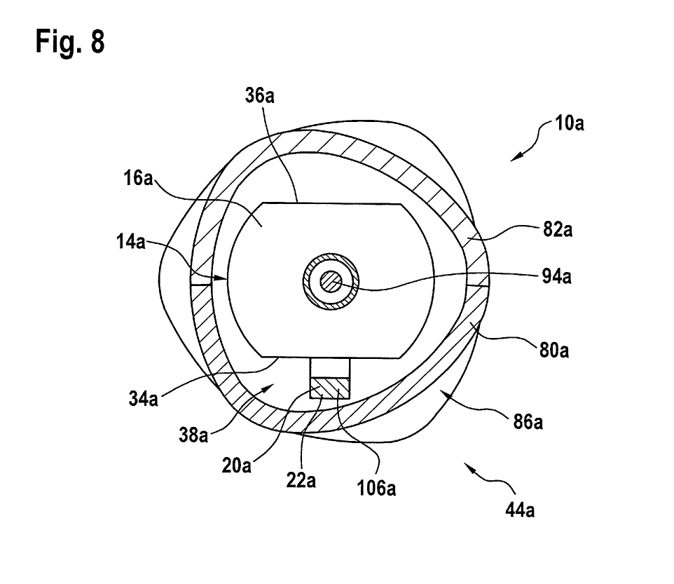

The motor unit 16a is formed by an electric motor. The motor unit 16a has two flattened portions 34a, 36a running parallel to an axis of rotation 32a of the motor unit 16a. The axis of rotation 32a forms an axis of rotation 32a of the motor shaft 94a and runs parallel to the main direction of extent 84a of the portable power tool 10a. The axis of rotation 32a forms an axis of rotation 32a for the entire active drive unit 14a. The motor unit 16a is of partially cylindrical design, with the two opposite flattened portions 34a, 36a which interrupt a cylindrical surface area of the motor unit 16a. The flattened portions 34a, 36a extend over an entire extent of the motor unit 16a, as viewed along the axis of rotation 32a. The motor unit 16a is arranged in the housing unit 44a in the region of the tapered portion 86a of the housing unit 44a (FIG. 8).

Furthermore, the portable power tool 10a has an electric switching element 18a which is provided for activating a rotational movement of the motor unit 16a. The electric switching element 18a is formed by an electric switch with a pushbutton 96a. The electric switching element 18a is arranged on a printed circuit board 98a of an activation unit 46a. The activation unit 46a is formed by an electronic control unit. The printed circuit board 98a of the activation unit 46a is of two-part design. A subregion 100a of the printed circuit board 98a has a main plane of extent which is oriented parallel to the main direction of extent 84a of the portable power tool 10a. A second subregion 102a of the portable power tool 10a has a main plane of extent which is oriented perpendicularly to the main direction of extent 84a of the portable power tool 10a. A particularly compact portable power tool 10a can be provided by bending the printed circuit board 98a down. The activation unit 46a is arranged behind the motor unit 16a in a region of the housing unit 44a that faces away from the tool-holding fixture 12a (FIGS. 2, 3).

Furthermore, the portable power tool 10a has an energy accumulation device 104a. The energy accumulation device 104a is formed by a battery device. The energy accumulation device 104a is formed by a cylindrical lithium-ion battery. In the activation unit 46a, the energy accumulation device 104a is arranged behind the motor unit 16a, in a region of the housing unit 44a that faces away from the tool-holding fixture 12a. A main direction of extent of the energy accumulation device 104a extends parallel to the main direction of extent 84a of the portable power tool 10a. The activation unit 46a is electrically connected to the energy accumulation device 104a via the electric switching element 18a (FIGS. 2, 3).

The activation unit 46a is provided for activating the active drive unit 14a. The activation unit 46a is provided for activating the motor unit 16a of the active drive unit 14a. The activation unit 46a is electrically connected (not specifically visible) to the motor unit 16a.

Furthermore, the portable power tool 10a has a mechanical switching element 20a for transmitting a switching signal along an axis of rotation 26a of the tool-holding fixture 12a to the electric switching element 18a over the entire active drive unit 14a. The mechanical switching element 20a is led past the motor unit 16a in a region 38a of the flattened portion 34a (FIG. 8). The mechanical switching element 20a is formed by a switching slide 22a. The switching slide 22a has a web-shaped subregion 106a which forms a substantial part of the switching slide 22a. The web-shaped subregion 106a forms a central subregion of the switching slide 22a. A main direction of extent of the web-shaped subregion 106a runs parallel to the main direction of extent 84a of the portable power tool 10a. Furthermore, a region of the switching slide 22a which faces away from the tool-holding fixture 12a has a subregion 24a which is angled in relation to the axis of rotation 26a of the tool-holding fixture 12a. The angled subregion 24a is directly connected to the web-shaped subregion 106a. A ring element 30a is arranged on a side of the switching slide 22a that faces away from the angled subregion 24a and on a side thereof that faces the tool-holding fixture 12a. The ring element 30a is provided for the form-fitting connection of the switching slide 22a to the tool-holding fixture 12a. The switching slide 22a is connected in a form-fitting manner to the tool-holding fixture 12a via the ring element 30a. The ring element 30a extends in a plane perpendicularly to the main direction of extent 84a of the portable power tool 10a. The ring element 30a is directly connected to the web-shaped subregion 106a of the switching slide 22a. The switching slide 22a is of integral design and is produced from polyoxymethylene (FIGS. 2, 3).

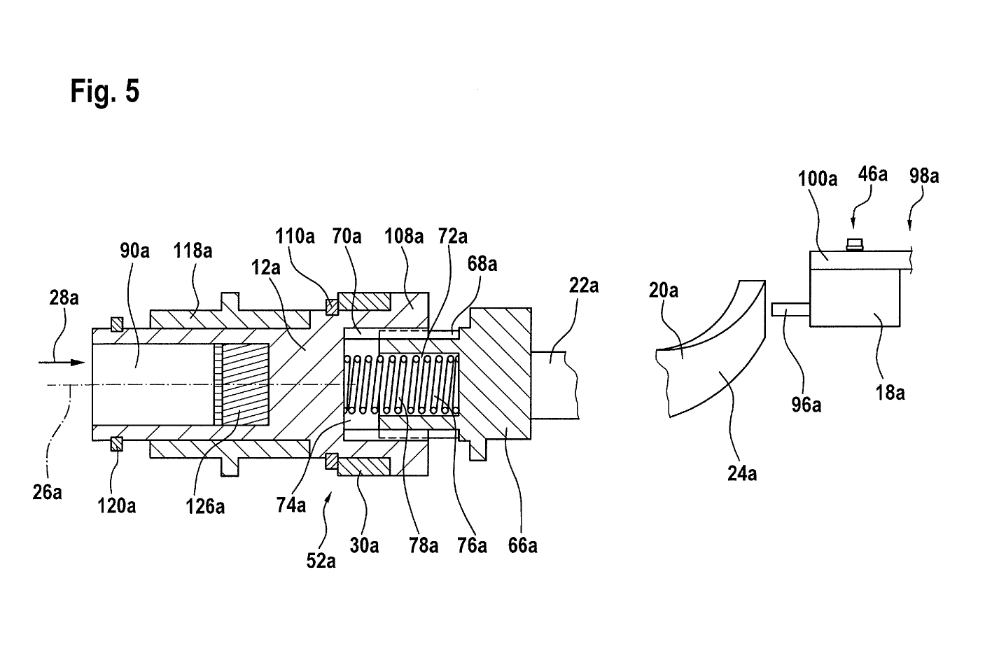

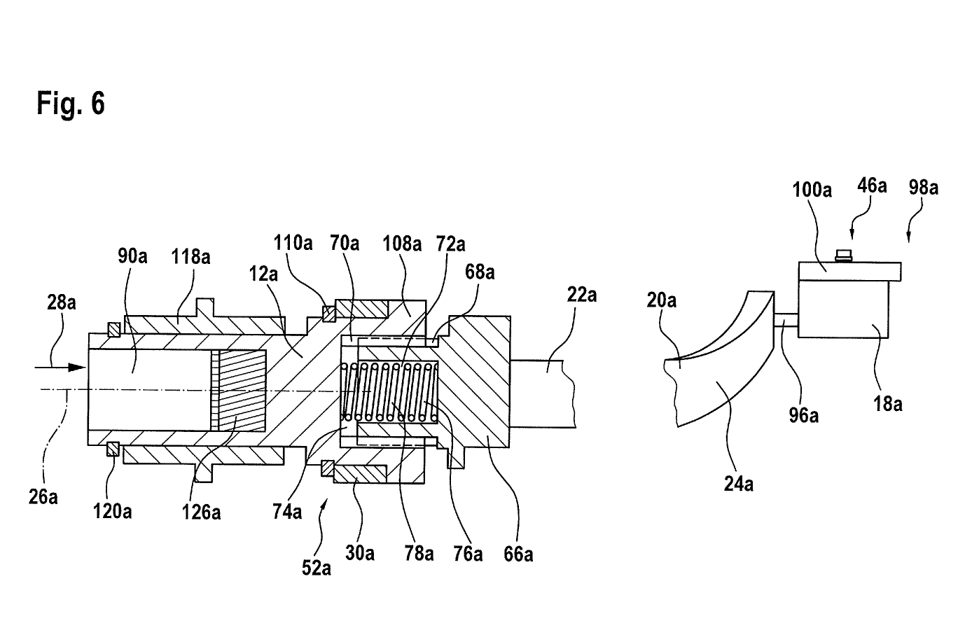

On a side facing the gearing unit 92a, the tool-holding fixture 12a has, as viewed along the main direction of extent 84a of the portable power tool 10a, an encircling elevation 108a which extends about the axis of rotation 26a in the circumferential direction. In a fitted state of the portable power tool 10a, the ring element 30a of the switching slide 22a bears against the elevation 108a and surrounds the tool-holding fixture 12a. On a side of the ring element 30a that faces away from the elevation 108a, a securing ring 110a is arranged in a groove. The ring element 30a is thereby connected to the tool-holding fixture 12a in a form-fitting manner axially and radially. The tool-holding fixture 12a is movable or rotatable in the circumferential direction in relation to the ring element 30a. By production of the switching slide 22a from polyoxymethylene, rotation between the ring element 30a and the tool-holding fixture 12a with little friction can advantageously be realized. The switching signal which is transmitted by the switching slide 22a is formed by an axial movement 28a of the tool-holding fixture 12a relative to the active drive unit 14a. The axial movement 28a of the tool-holding fixture 12a is transmitted to the entire switching slide 22a via the ring element 30a. The switching signal is intended to indicate an activation of the portable power tool 10a. If the tool-holding fixture 12a carries out an axial movement 28a in the direction of the active drive unit 14a, in particular caused by an operator pressing the portable power tool 10a onto a work surface, this is intended to indicate that an operator wishes for the portable power tool 10a to be activated. The axial movement 28a of the tool-holding fixture 12a causes the switching slide 22a to likewise carry out the axial movement 28a. In the process, the angled subregion 24a of the switching slide 22a presses the pushbutton 96a of the electric switching element 18a inwards and thereby closes a contact of the electric switching element 18a. The activation unit 46a is supplied with energy from the energy accumulation device 104a via the electric switching element 18a (FIGS. 5, 6).

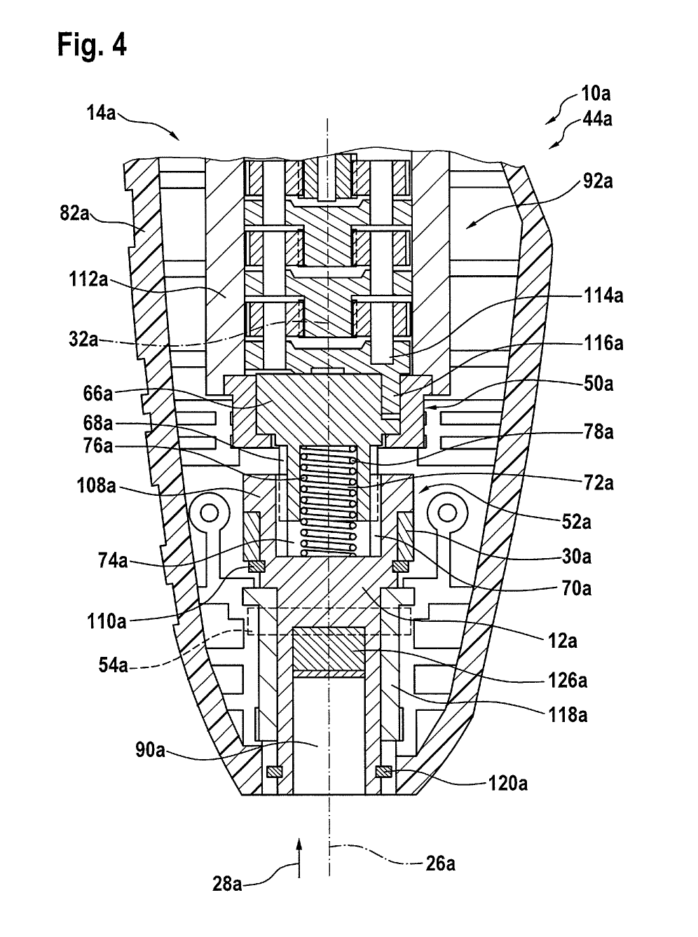

A spindle lock device 50a and a drive spindle 66a are arranged spatially and also along a force flux between the gearing unit 92a and the tool-holding fixture 12a. The spindle lock device 50a is provided for preventing a rotational movement of the tool-holding fixture 12a when the portable power tool 10a is switched off. The spindle lock device 50a is provided for blocking the tool-holding fixture 12a against rotation in the event of transmission of the rotational speed and/or torque by the active drive unit 14a failing. The spindle lock device 50a is directly connected to the gearing unit 92a. The spindle lock device 50a is arranged in the housing unit 112a of the gearing unit 92a. A final planet carrier 114a of the gearing unit 92a, which planet carrier is assigned to the spindle lock device 50a, is formed integrally with a carry-along element 116a of the spindle lock device 50a. The planet carrier 114a transmits a rotational movement of the gearing unit 92a to the carry-along element 116a of the spindle lock device 50a. The carry-along element 116a transmits a rotational movement of the gearing unit 92a via cylindrical rollers (not visible specifically) to the drive spindle 66a which is mounted in the housing unit 112a of the gearing unit 92a. A transmission of a rotational movement from the drive spindle 66a via the cylindrical rollers (not visible specifically) to the carry-along element 116a is prevented by the spindle lock device 50a. By transmission of a rotational movement from the drive spindle 66a via the cylindrical rollers (not visible specifically) to the carry-along element 116a, the cylindrical rollers (not visible specifically) become wedged between the drive spindle 66a and the housing unit 112a in the region of the spindle lock device 50a, thus preventing a rotational movement. The tool-holding fixture 12a is driven by the active drive unit 14a via the drive spindle 66a. The drive spindle 66a is sintered and is subjected to a curing process during production. Calibrated tools are used for the sintering (FIG. 4).

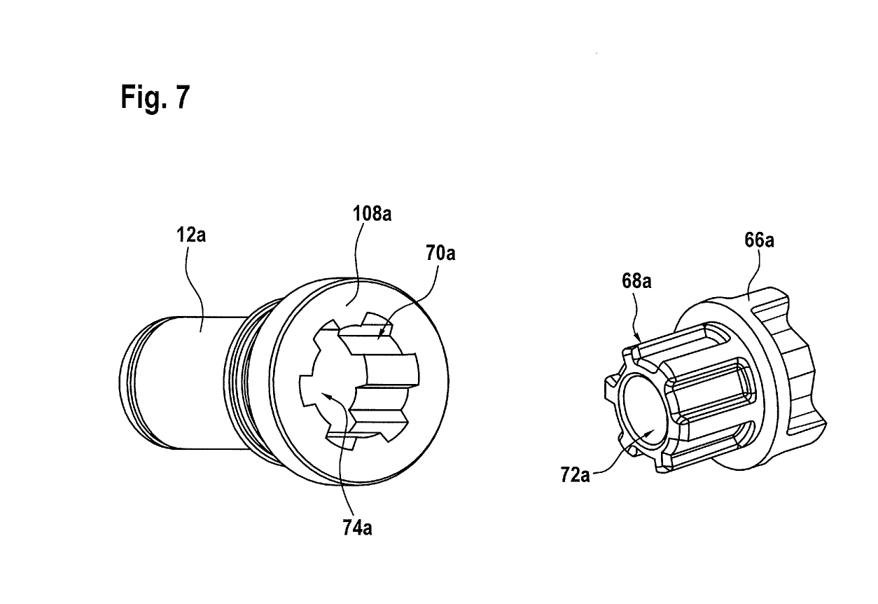

The tool-holding fixture 12a and the drive spindle 66a are formed separately from each other and are connected in the circumferential direction via a form-fitting connection 52a. The form-fitting connection 52a is located on a side of the drive spindle 66a that faces away from the gearing unit 92a. The form-fitting connection 52a serves for transmitting rotational speed and torque between the drive spindle 66a and the tool-holding fixture 12a. The form-fitting connection 52a is formed by splines 68a, 70a in each case corresponding to one another. The drive spindle 66a has an outer spline 68a which corresponds to an inner spline 70a of the tool-holding fixture 12a. A fit between the splines 68a, 70a of the drive spindle 66a and the tool-holding fixture 12a is designed as a sliding fit. Between the tool-holding fixture 12a and the active drive unit 14a there is circumferential play in the circumferential direction about the axis of rotation 26a of the tool-holding fixture 12a. The form-fitting connection 52a has circumferential play in the circumferential direction about the axis of rotation 26a of the drive spindle 66a and the tool-holding fixture 12a. There is circumferential play between the outer spline 68a of the drive spindle 66a and the inner spline 70a of the tool-holding fixture 12a. The circumferential play is circa 2°. Furthermore, the drive spindle 66a and the tool-holding fixture 12a are arranged displaceably with respect to each other in an axially limited manner via the form-fitting connection 52a. The splines 68a, 70a of the form-fitting connection 52a have axially running tooth faces, as a result of which the splines 68a, 70a are displaceable axially relative to each other. The drive spindle 66a is arranged in a positionally fixed manner axially and radially in the housing unit 44a of the portable power tool 10a. The tool-holding fixture 12a is arranged in a positionally fixed manner radially in the housing unit 44a of the portable power tool 10a via a plain bearing 118a. The tool-holding fixture 12a is movable in an axially limited manner in the plain bearing 118a. During an axial movement 28a of the tool-holding fixture 12a, the plain bearing 118a, on a side facing the drive spindle 66a, strikes against a step in the tool-holding fixture 12a and, on a side facing away from the drive spindle 66a, strikes against a securing ring 120a in a groove of the tool-holding fixture 12a. The plain bearing 118a is fixedly connected to the housing unit 44a of the portable power tool 10a (FIGS. 4, 7).

In the region of the form-fitting connection 52a, the tool-holding fixture 12a and the drive spindle 66a respectively have a receiving region 72a, 74a for receiving a resetting element 76a. The receiving regions 72a, 74a are each directed towards each other and therefore form a large, closed receiving region. The receiving region 72a of the drive spindle 66a is formed by a cylindrical recess on an end surface facing the tool-holding fixture 12a. The receiving region 74a of the tool-holding fixture 12a is formed by a cylindrical recess, on the surface area of which the inner spline 70a is arranged. The resetting element 76a is provided for moving the tool-holding fixture 12a in relation to the drive spindle 66a into a basic position or for holding said tool-holding fixture therein. The “basic position” is intended to be understood as meaning a maximum possible axial extent of the drive spindle 66a together with the tool-holding fixture 12a along the main direction of extent 84a. In the basic position, the plain bearing 118a bears against the step in the tool-holding fixture 12a and delimits a further axial extent. The resetting element 76a is formed by a helical spring 78a. In a fitted state, the resetting element 76a is supported axially both on the drive spindle 66a and on the tool-holding fixture 12a and pushes them apart with a restoring force. The force exerted by the weight of the portable power tool 10a is smaller than the restoring force of the resetting element 76a. Owing to the fact that the force exerted by the weight of the portable power tool 10a is smaller than the restoring force of the resetting element 76a, a mounting of the portable power tool 10a can be made possible without the portable power tool 10a being activated unintentionally (FIG. 4).

The activation unit 46a has a detection unit 48a for determining a desired operating state. The detection unit 48a is provided for detecting characteristic variables of a difference in rotational speed between the tool-holding fixture 12a and the active drive unit 14a in the circumferential direction about the axis of rotation 32a of the active drive unit 14a and the axis of rotation 26a of the tool-holding fixture 12a. The axis of rotation 32a of the active drive unit 14a is arranged coaxially with respect to the axis of rotation 26a of the tool-holding fixture 12a. The activation unit 46a is provided for determining a desired direction of rotation of the tool-holding fixture 12a. The detection unit 48a is furthermore provided for detecting a characteristic variable of circumferential play in the circumferential direction about the axis of rotation 26a of the tool-holding fixture 12a in order to determine a desired direction of rotation (FIGS. 2, 3).

The detection unit 48a has a sensor unit 56a which is provided for detecting a rotational movement of the housing unit 44a relative to the tool-holding fixture 12a. The sensor unit 56a is provided for detecting a rotational movement of the housing unit 44a relative to the surroundings. The sensor unit 56a has a measurement axis 58a which is oriented coaxially with respect to the axis of rotation 26a of the tool-holding fixture 12a. The sensor unit 56a is formed by a rate of rotation sensor 60a. The rate of rotation sensor 60a is arranged on the printed circuit board 98a of the activation unit 46a. The rate of rotation sensor 60a is arranged on the second subregion 102a of the printed circuit board 98a. The rate of rotation sensor 60a is arranged on the printed circuit board 98a on the axis of rotation 26a of the tool-holding fixture 12a (FIGS. 2, 3).

Furthermore, the detection unit 48a has a sensor unit 54a for detecting a characteristic variable of a rotational speed of the tool-holding fixture 12a. The sensor unit 54a is formed by a rotational speed sensor. The sensor unit 54a is formed by a Hall sensor. The sensor unit 54a is provided for detecting a rotational movement of the tool-holding fixture 12a relative to the active drive unit 14a and relative to the housing unit 44a. A transmitter ring of the sensor unit 54a is fixedly connected to the tool-holding fixture 12a. A sensor element of the sensor unit 54a is fixedly connected to the housing unit 44a (FIG. 4).

For planned operation of the portable power tool 10a by an operator, in a first step a tool (not visible specifically) is inserted into the tool-holding fixture 12a. If the portable power tool 10a, with the tool-holding fixture 12a in front, is then pushed along the main direction of extent 84a against a work surface, in particular against a screw, the tool-holding fixture 12a is displaced axially towards the drive spindle 66a. As a result, the switching slide 22a is pushed simultaneously axially in the direction of the electric switching element 18a. In the process, the angled subregion 24a of the switching slide 22a presses the pushbutton 96a of the electric switching element 18a inwards and thereby closes a contact of the electric switching element 18a (FIG. 6). The activation unit 46a is thereby supplied with energy from the energy accumulation device 104a and is thereby activated. If the portable power tool 10a is then rotated in a desired direction of rotation, the tool-holding fixture 12a experiences inertia because of the screw in which a tool of the tool-holding fixture 12a sits. This results in a relative movement between the tool-holding fixture 12a and the rest of the portable power tool 10a, said relative movement being made possible by the circumferential play of the form-fitting connection 52a. Said relative movement is detected in the form of a difference in rotational speed via the sensor units 54a, 56a. The activation unit 46a thus determines a desired direction of rotation via the detection unit 48a. The activation unit 46a subsequently activates the motor unit 16a in a manner corresponding to the desired direction of rotation and the motor unit 16a starts in the predetermined direction of rotation. If an operator wishes to end operation of the portable power tool 10a or to change a direction of rotation, the operator applies a pressure from the portable power tool 10a to the screw. The tool-holding fixture 12a is moved back into the basic position by the resetting element 76a. In the process, the switching slide 22a moves away axially from the electric switching element 18a, the pushbutton 96a moves outwards and the contact of the electric switching element 18a is opened (FIG. 5). The operation can then be ended or the procedure can be begun again in order to change a direction of rotation. This makes it possible in particular for intuitive control to be achieved. Furthermore, a separate on/off switch can be omitted, as a result of which, in turn, a simple and cost-effective sealing of the electric tool, for example against dirt, water or dust, can be realized.

In principle, however, it would also be conceivable for a desired direction of rotation to be set via a manual control element, and therefore, for example, a sensor arrangement could be omitted.

In principle, however, it would also be conceivable for the detection unit 48a to be provided for detecting a characteristic variable of a relative force between the tool-holding fixture 12a and the active drive unit 14a. For this purpose, a force transducer (not visible specifically) could be integrated into the form-fitting connection 52a, the force transducer detecting a relative force in the circumferential direction between the splines 68a, 70a. As a result, a desired direction of rotation can be detected.

In principle, it would also be conceivable for the detection unit 48a to be provided for detecting a characteristic variable of a torque between the tool-holding fixture 12a and the active drive unit 14a. For this purpose, a sensor unit (not visible specifically) which determines a torque between the tool-holding fixture 12a and the active drive unit 14a could be fitted. In particular, no circumferential play would be required for this.

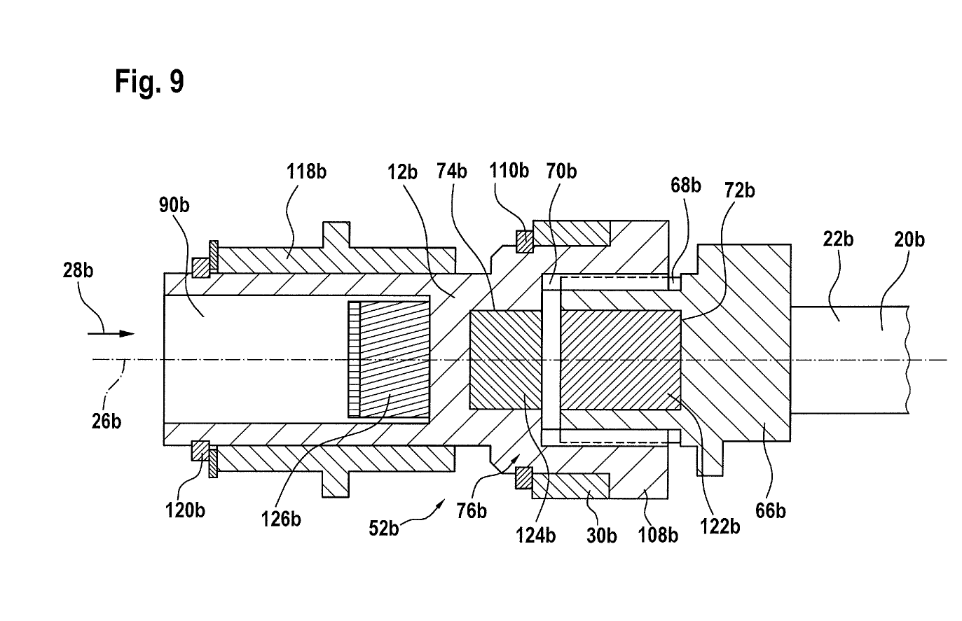

FIGS. 9 to 14 show further exemplary embodiments of the disclosure. The descriptions below and the drawings are essentially limited to the differences between the exemplary embodiments, wherein, with regard to components denoted identically, in particular with regard to components having identical reference numbers, reference can be made in principle also to the drawings and/or the description of the other exemplary embodiments, in particular of FIGS. 1 to 8. In order to differentiate the exemplary embodiments, the letter a is placed after the reference numbers of the exemplary embodiment in FIGS. 1 to 8. In the exemplary embodiments of FIGS. 9 to 14, the letter a has been replaced by the letters b to f.

FIG. 9 shows a tool-holding fixture 12b, a drive spindle 66b, a mechanical switching element 20b and a resetting element 76b of an alternative portable power tool 10b according to the disclosure. The resetting element 76b is formed by two magnet elements 122b, 124b. The magnet element 122b is arranged in a receiving region 72b of the drive spindle 66b. The second magnet element 124b is arranged in a receiving region 74b of the tool-holding fixture 12b. The magnet elements 122b, 124b are adhesively bonded into the receiving regions 72b, 74b. The magnet elements 122b, 124b repulse each other.

In principle, it would also be conceivable for the magnet element 124b which is arranged in the receiving region 74b of the tool-holding fixture 12b to be formed integrally with a magnet element 126b of a bit holder 90b of the tool-holding fixture 12a.

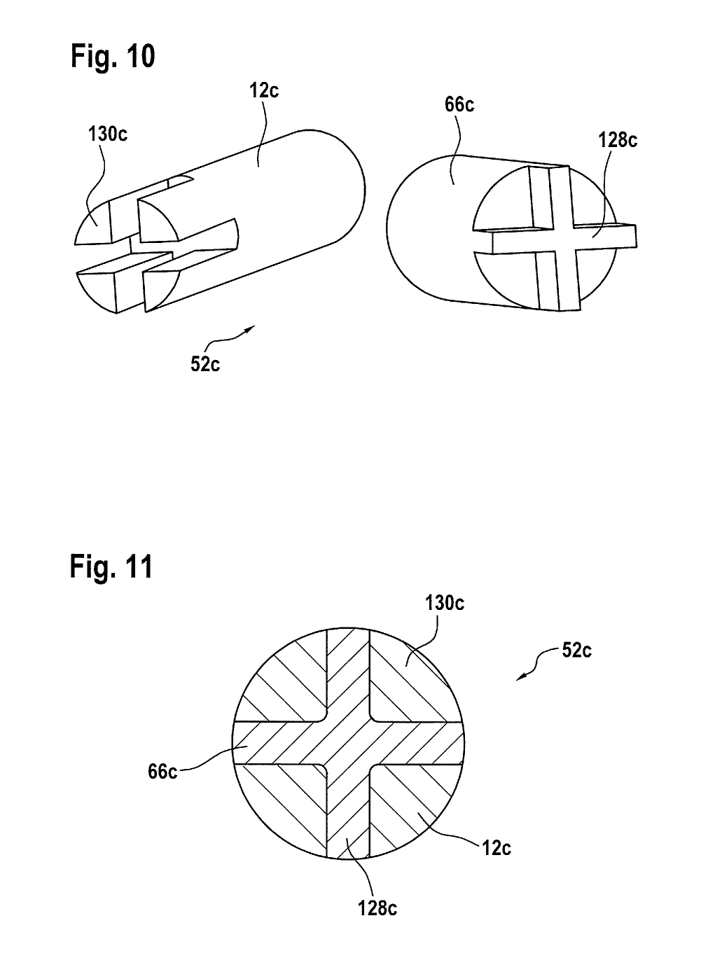

FIG. 10 shows a schematic exploded illustration of a tool-holding fixture 12c and a drive spindle 66c, with a form-fitting connection 52c of a further alternative portable power tool 10c according to the disclosure. The form-fitting connection 52c is formed by corresponding cross-recessed connecting elements 128c, 130c. The drive spindle 66c has the first cross-recessed connecting element 128c. The cross-recessed connecting element 128c is formed by an axial extension. The cross-recessed element 128c has a constant cross-shaped cross section, as viewed perpendicularly to an axis of rotation 26c of the tool-holding fixture 12c. The tool-holding fixture 12c has the second cross-recessed connecting element 130c. The cross-recessed connecting element 130c is formed by an axial extension. The cross-recessed element 130c is formed by a cylindrical extension with an axially extending recess. The recess has a constant cross-shaped cross section, as viewed perpendicularly to the axis of rotation 26c of the tool-holding fixture 12c. The second cross-recessed connecting element 130c forms a negative of the first cross-recessed connecting element 128c (FIG. 11). For reasons of clarity, receiving regions 72c, 74c for a resetting element 76c are not illustrated specifically here.

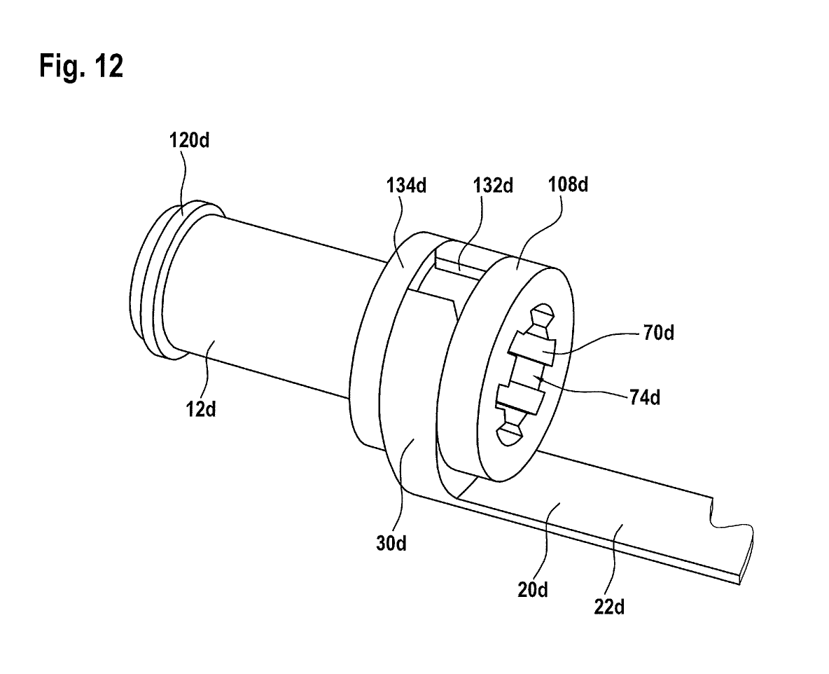

FIG. 12 shows a tool-holding fixture 12d and a mechanical switching element 20d of a further alternative portable power tool 10d according to the disclosure. The mechanical switching element 20d is formed by a switching slide 22d. The switching slide 22d has a web-shaped subregion 106d which forms a substantial part of the switching slide 22d. On a side of the switching slide 22d that faces the tool-holding fixture 12d, said switching slide has a ring element 30d. The ring element 30d is designed in the form of part of a circle and accordingly has an interruption 132d. The interruption 132d is arranged opposite a connecting point with the web-shaped subregion 106d. The ring element 30d is provided for the form-fitting connection of the switching slide 22d to the tool-holding fixture 12d. The switching slide 22d is connected in a form-fitting manner to the tool-holding fixture 12d via the ring element 30d. The ring element 30d extends in a plane perpendicularly to a main direction of extent 84d of the portable power tool 10d.

On a side facing a gearing unit 92d, the tool-holding fixture 12d has, as viewed along the main direction of extent 84d of the portable power tool 10d, two encircling elevations 108d, 134d which extend in the circumferential direction about an axis of rotation 26d. In a fitted state of the portable power tool 10d, the ring element 30d of the switching slide 22d is arranged directly between the elevations 108d, 134d and surrounds the tool-holding fixture 12d. For installation, because of the interruption 132d, the ring element 30d can simply be clipped onto the tool-holding fixture 12d.

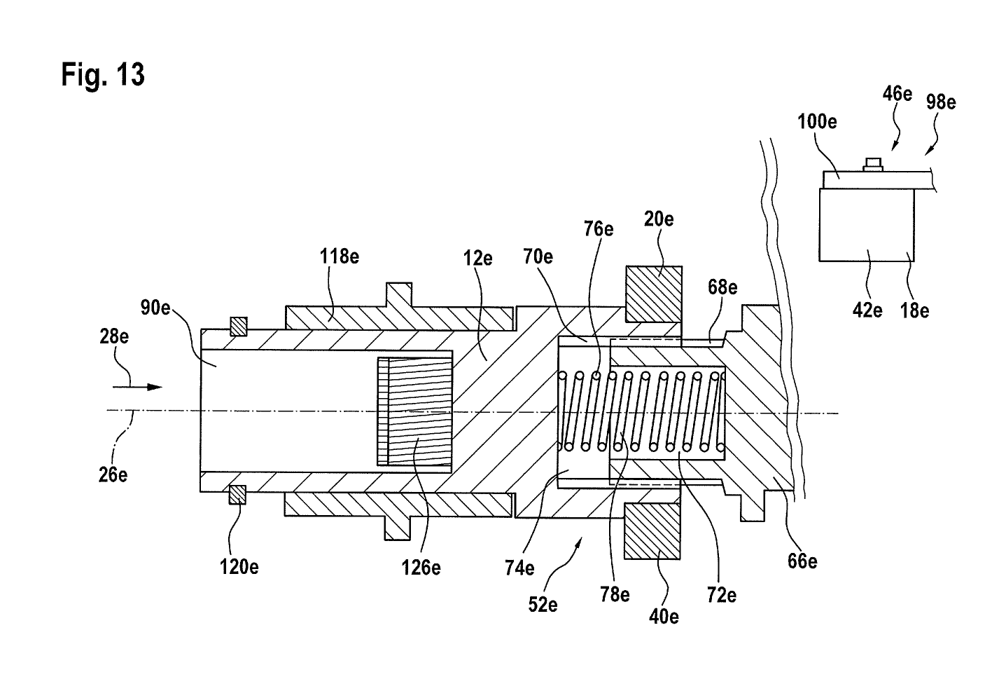

FIG. 13 shows a tool-holding fixture 12e, a drive spindle 66e, a mechanical switching element 20e and an electric switching element 18e of a further alternative portable power tool 10e according to the disclosure. The mechanical switching element 20e is formed by a magnet element 40e. The magnet element 40e is formed by a permanent magnet ring which is pressed on a side facing the drive spindle 66e onto the tool-holding fixture 12e. The magnet element 40e is provided for transmitting a switching signal to the electric switching element 18e over an active drive unit 14e. The electric switching element 18e is formed by a Reed switch 42e. The electric switching element 18e is arranged on a printed circuit board 98e of an activation unit 46e.

If the magnet element 40e then approaches the Reed switch 42e because of pressure on the tool-holding fixture 12e, the magnetic field of the magnet element 40e moves towards the Reed switch 42e. The approach of the magnetic field causes two contact elements of the Reed switch 42e to move towards each other until they touch and close a contact.

In principle, it would also be conceivable for the magnet element 40e to be formed integrally with a resetting element 76e which is formed by two magnet elements and/or to be formed integrally with a magnet element 126e of a bit holder 90e of the tool-holding fixture 12e.

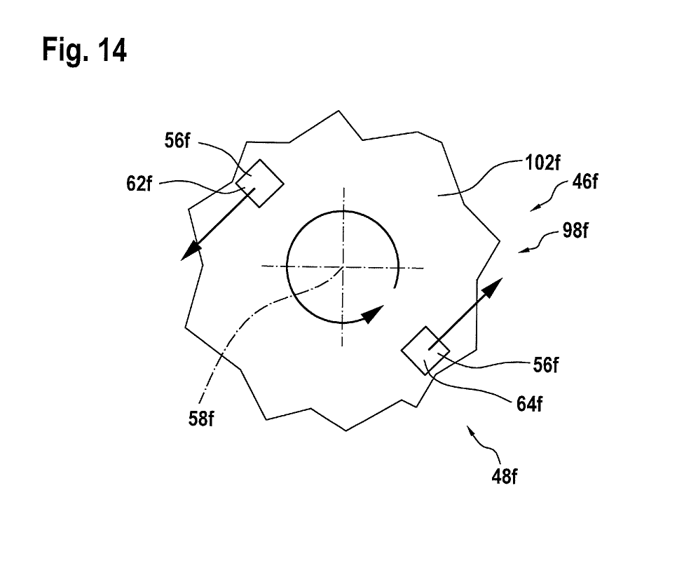

FIG. 14 shows a sensor unit 56f of a further alternative portable power tool 10f according to the disclosure. The sensor unit 56f is formed by two acceleration sensors 62f, 64f. The sensor unit 56f has a measuring axis 58f which is oriented coaxially with respect to an axis of rotation 26f of a tool-holding fixture 12f. The acceleration sensors 62f, 64f are arranged on a printed circuit board 98f of an activation unit 46f. The acceleration sensors 62f, 64f are arranged on a second subregion 102f of the printed circuit board 98f. The acceleration sensors 62f, 64f are arranged on the printed circuit board 98f in such a manner that they are at an identical distance from the axis of rotation 26f of the tool-holding fixture 12f. The acceleration sensors 62f, 64f are arranged on opposite sides of the axis of rotation 26f of the tool-holding fixture 12f.

What is claimed is:

1. A portable power tool, comprising:
a tool-holding fixture;
at least one active drive unit including at least one motor unit;
at least one electric switching element configured to activate a rotational movement of the motor unit; and
at least one mechanical switching element configured to transmit a switching signal along an axis of rotation of the tool-holding fixture to the electric switching element over at least part of the active drive unit.

2. The portable power tool according to claim 1, wherein the mechanical switching element is configured to transmit a switching signal along the axis of rotation of the tool-holding fixture to the electric switching element over the entire active drive unit.

3. The portable power tool according to claim 1, wherein the mechanical switching element includes a switching slide.

4. The portable power tool according to claim 3, wherein a region of the switching slide that faces away from the tool-holding fixture has a subregion which is angled in relation to the axis of rotation of the tool-holding fixture.

5. The portable power tool according to claim 1, wherein the switching signal is at least partially formed by an axial movement of the tool-holding fixture relative to at least part of the active drive unit.

6. The portable power tool according to claim 5, wherein the mechanical switching element is configured at least partially in a form-fitting manner with the tool-holding fixture.

7. The portable power tool according to claim 6, wherein the mechanical switching element has a ring element on a side facing the tool-holding fixture, the ring element being configured to form-fittingly connect to the tool-holding fixture.

8. The portable power tool according to claim 1, wherein the motor unit has at least one flattened portion running parallel to an axis of rotation of the motor unit.

9. The portable power tool according to claim 8, wherein the mechanical switching element is led past the motor unit in a region of the flattened portion.

10. The portable power tool according claim 1, wherein the mechanical switching element includes a magnet element configured to transmit a switching signal to the electric switching element over at least part of the active drive unit.

11. The portable power tool according to claim 10, wherein the electric switching element is configured as a Reed switch.

12. A switching slide for a portable power tool, the portable power tool including a tool-holding fixture, at least one active drive unit including at least one motor unit, at least one electric switching element configured to activate a rotational movement of the motor unit, and at least one mechanical switching element configured to transmit a switching signal along an axis of rotation of the tool-holding fixture to the electric switching element over at least part of the active drive unit, wherein the mechanical switching element includes the switching slide, and wherein a region of the switching slide that faces away from the tool-holding fixture has a subregion which is angled in relation to the axis of rotation of the tool-holding fixture.

13. The switching slide of claim 12, wherein the switching slide is at least partially formed from polyoxymethylene.

14. The portable power tool according to claim 1, wherein the portable power tool is configured as a portable screwdriver.

15. The portable power tool according to claim 3, wherein the switching slide is at least partially formed from polyoxymethylene.
